(19) United States
(12) Patent Application Publication
(10) Pub. No.: US 2016/0235099 A1
(43) Pub. Date: Aug. 18, 2016

(54) Method for Producing Agent for Improving Untangling of Noodles

(71) Applicant: FUJI OIL HOLDINGS INC., Izumisano-shi, Osaka (JP)

(72) Inventors: Nanae FUJII, Tsukubamirai-shi (JP); Norifumi ADACHI, Tsukubamirai-shi (JP)

(73) Assignee: Fuji Oil Holdings Inc., Izumisano-shi (JP)

(21) Appl. No.: 15/022,415

(22) PCT Filed: Sep. 17, 2014
(86) PCT No.: PCT/JP2014/074512

§ 371 Date: Mar. 16, 2016

(30) Foreign Application Priority Data
Sep. 17, 2013 (JP) 2013-191707

(51) Int. Cl. A23L 1/16

(52) U.S. Cl. CPC A23L 1/162; A23L 1/1613; A23L 1/035; A23V 2002/00

(57) ABSTRACT

An object of the present invention is to provide a method for producing an untangling-improving agent for inhibiting quality deterioration such as a difficulty in untangling after storage and efficiently producing tasty noodles, and to provide noodles prepared by using the untangling-improving agent. The untangling properties of noodles can be improved, and at the same time, the elasticity and chewiness of noodles can be maintained by adding, to noodles, an untangling-improving agent for noodles obtained by incorporating monoglycerol fatty acid ester and protein, wherein the monoglycerol fatty acid ester and protein are in the emulsified state.

### TECHNICAL FIELD

The present invention relates to a method for producing an untangling-improving agent for noodles.

### BACKGROUND ART

With recent diversification of food consumption, the need for processed food is on the rise. Particularly, processed and cooked noodle products have come to be sold in large quantities in convenience stores, supermarkets, and the like and eaten by many consumers.

Particular problems associated with those processed foods that are distributed and sold on the market are the convenience of processing and quality deterioration occurring with time. Generally, noodles contain starch, and starchy materials ooze out to the surface of foods during processing and cooking, allowing foods to stick together. As a result, it becomes difficult to divide noodles into single-serving portions or mix them with soup or sauce at the time of consumption due to adhesion between noodles. In the case of instant noodles, the part where noodles stick together is not rehydrated easily with hot water. These problems lead to a reduction in production efficiency and an increase in cost, and moreover, bring about results such that the final food products are not only difficult to eat at the time of consumption but are not tasty.

As a conventional method for breaking the aforementioned adhesion between foods and improving their untangling properties, a method including adding a liquid having an untangling function to noodle strands is known. For example, there is a method including mixing oil or fat or emulsified oil or fat (Patent Literature 1); however, when oil or fat is used in an untangling agent, oil floats on top of the soup at the time of consumption, and therefore, this method cannot be applied to noodles such as somen noodles, soba noodles, and udon noodles either. There are other methods such as a method including adding sucrose fatty acid ester having high HLB (Patent Literature 2), a method including adding organic acid (Patent Literature 3), a method including carrying out processing while applying mechanical vibrations, and a method including using water soluble hemicellulose (Patent Literature 4); however, sufficient untangling properties cannot be obtained with any of these methods, and moreover, there is a problem that the texture is deteriorated when only emulsifiers are used.

Conventionally, a method including kneading noodle dough with the addition of an untangling agent is known. For example, there are methods such as a method including kneading with the addition of alginic acid, followed by boiling in hot water containing calcium (Patent Literature 5), a method including adding powdered oil or fat, which is obtained by drying and powderizing an O/W emulsion containing edible oil or fat, a coating agent, and an emulsifier (Patent Literature 6), and a method including kneading with the addition of protein-coated starch (Patent Literature 7); however, sufficient untangling properties could not be obtained with any of these methods, and moreover, there was a problem that the texture of noodles was deteriorated. Patent Literature 8 describes a method including allowing an emulsifier to be held by an edible carrier; however, the resulting carriers have poor water dispersibility and is not suitable for long-term storage.

### CITATION LIST

### Patent Literature

Patent Literature 1: JP H03-175940
Patent Literature 2: JP S60-8103
Patent Literature 3: JP S61-181350
Patent Literature 4: JP H06-121647
Patent Literature 5: JP 2002-281923
Patent Literature 6: JP 2007-222139
Patent Literature 7: JP 2003-023978
Patent Literature 8: JP 2000-157190

### SUMMARY OF INVENTION

### Technical Problem

An object of the present invention is to provide a method for producing an untangling-improving agent for inhibiting quality deterioration such as a difficulty in untangling after storage and efficiently producing tasty noodles, and to provide noodles prepared by using the untangling-improving agent.

### Solution to Problem

In light of the aforementioned problem, the present inventors conducted intensive research, and as a result, they have found that by adding, to noodles, an untangling-improving agent for noodles comprising monoglycerol fatty acid ester and protein, wherein the monoglycerol fatty acid ester and protein are in the emulsified state, the untangling properties of noodles can be improved, and at the same time, the elasticity and chewiness of noodles can be maintained, thereby completing the present invention.

That is, the present invention relates to:
(1) a method for producing an untangling-improving agent for noodles, comprising incorporating a monoglycerol fatty acid ester and a protein, wherein the monoglycerol fatty acid ester and protein are in the emulsified state,
(2) the method for producing an untangling-improving agent for noodles according to (1), wherein the monoglycerol fatty acid ester is a distilled monoglycerol fatty acid ester,
(3) the method for producing an untangling-improving agent for noodles according to (1) or (2), comprising further incorporating a water soluble hemicellulo se,
(4) the method for producing an untangling-improving agent for noodles according to any one of (1) to (3), comprising further incorporating one or more emulsifier(s) selected from the group consisting of organic acid esters of monoglycerides, lecithin, and stearoyl lactylate,
(5) the method for producing an untangling-improving agent for noodles according to any one of (1) to (4), wherein the protein is one or more heat-coagulable protein(s) selected from proteins derived from beans, wheat, and egg white,
(6) a method for producing noodles, comprising adding the untangling-improving agent for noodles obtained by the production method according to any one of (1) to (5) to noodle dough, or comprising preparing a solution by dissolving the untangling-improving agent for noodles in water and adding the solution to noodle strands through a surface treatment, and
(7) noodles prepared by using the untangling-improving agent for noodles obtained by the production method according to any one of (1) to (5).

### Advantageous Effects of Invention

According to the present invention, by adding, to noodles, an untangling-improving agent for noodles obtained by incorporating monoglycerol fatty acid ester and protein, wherein the monoglycerol fatty acid ester and protein are in the emulsified state, the untangling properties of noodles can be improved even after refrigeration, and at the same time, an effect of maintaining the elasticity and chewiness of noodles is also exerted.

### DESCRIPTION OF EMBODIMENTS

Hereinbelow, the present invention will be specifically described.

(Noodles)

In the present invention, noodles refer to dried noodles, fresh noodles, fried noodles, hot air-dried instant noodles, freeze-dried instant noodles, and the like, specifically, soba noodles, udon noodles, kishimen noodles, Chinese noodles, pasta, macaroni, somen noodles, pho, Korean cold noodles, cellophane noodles, and the like.

These noodles include not only noodles cooked at home but also processed foods in the form of final commercial products intended to be consumed at the site where they are provided and semi-finished products that need to be cooked at the time of consumption, and foods distributed to the market by means of transportation at normal temperature, refrigeration and freezing, and transportation at ice-cold temperature, and the like.

(Untangling-Improving Agent for Noodles)

The untangling-improving agent for noodles of the present invention is produced by incorporating monoglycerol fatty acid ester and protein, wherein the monoglycerol fatty acid ester and protein are in the emulsified state. Also, it is preferable that water soluble hemicellulose and/or one or more emulsifier(s) selected from organic acid esters of monoglycerides, lecithin, and stearoyl lactylate be further contained since the untangling properties of noodles and the quality of noodles are further improved.

The blending ratio between protein and monoglycerol fatty acid ester in the untangling-improving agent is not particularly limited. It is preferable to incorporate protein and monoglycerol fatty acid ester at a ratio of protein:monoglycerol fatty acid ester=1:0.1 to 1:10. More preferably, protein and monoglycerol fatty acid ester are incorporated at a ratio of protein:monoglycerol fatty acid ester=1:0.5 to 1:5. When the content of protein is small, the texture of noodles may tend to be too hard, and when the content of monoglycerol fatty acid ester is too small, the untangling properties of noodles may be insufficient.

It is important to bring monoglycerol fatty acid ester and protein in the untangling-improving agent for noodles of the present invention to the emulsified state, and then dry the resulting emulsion. The emulsified state means that monoglycerol fatty acid ester and protein are in the state of an emulsion of any of oil-in-water emulsions, water-in-oil emulsions, and emulsions that are in between. In the present invention, a powdered form obtained by drying an oil-in-water emulsion or a granular form obtained by granulating the aforementioned powder is preferable, of which a powdered form is more preferable. Kneading noodle dough with the addition of monoglycerol fatty acid ester and protein or spraying them to noodle strands is made easy by including monoglycerol fatty acid ester and protein in the emulsified state, allowing these protein and monoglycerol fatty acid ester components to be evenly dispersed in the entire noodle dough, and as a result, an improvement in the untangling properties of noodles and the quality of noodles (hardness of noodles and elasticity of noodles) brought about by these components can be effectively exerted. Meanwhile, if noodle dough is kneaded with the addition of protein and monoglycerol fatty acid ester or protein and monoglycerol fatty acid ester are sprayed to noodle strands without them being made into an oil-in-water emulsion, it becomes difficult to evenly mix them nicely in the dough, possibly leading to a failure in preparing good dough itself, and it also becomes difficult to evenly spray them to noodle strands. Consequently, an effect of improving the untangling properties of noodles and the quality of noodles is impaired as well.

(Protein)

It is preferable to use heat-coagulable protein made from beans such as soybean, pea, and mung bean, wheat, and egg white as protein in the present invention, and protein of beans such as soybean, pea, and mung bean is more preferable. Also, soybean protein is more preferable since cost can be reduced and texture is enriched with chewiness and elasticity. Examples of soybean protein include soybean protein isolate, alkaline earth metal-conjugated soybean protein isolate, soybean protein concentrate, whole soybean milk, whole soybean milk powder, defatted soybean milk, defatted soybean milk powder, and alkaline earth metal-conjugated defatted soybean milk or defatted soybean milk powder. One or more of these proteins can be used in combination.

A production method of protein is not particularly limited as long as it is a method commonly practiced in food production, and protein is produced through steps such as hydration extraction, isoelectric precipitation, membrane separation, washing with water, purification, and desugaring. If necessary, it is also possible to use proteins that have been degraded with acid, alkali, enzymes, and the like. Protein in the emulsified state encompasses, in addition to protein that is present in a liquid, a substance resulting from drying a liquid in the emulsified state.

(Emulsion)

As the emulsion used in the present invention, it is essential to use monoglycerol fatty acid ester in the emulsified state. Monoglycerol fatty acid ester in the emulsified state encompasses, in addition to monoglycerol fatty acid ester that is present in a liquid, a substance resulting from drying a liquid in the emulsified state.

While monoglycerol fatty acid ester is not particularly limited by fatty acid composition, the purity of monoglycerol fatty acid ester strongly influences the untangling properties of noodles. Therefore, it is preferable to use distilled monoglycerol fatty acid ester which contains highly pure monoglycerol fatty acid ester. The purity of monoglyceride in distilled monoglycerol fatty acid ester is preferably 80% by weight or more, more preferably 85 by weight or more.

Also, it is preferable to simultaneously use one or more emulsifies(s) selected from the group consisting of organic acid esters of monoglycerides, lecithin, and stearoyl lactylate since the untangling properties of noodles and the quality of noodles are improved. Examples of organic acid esters of monoglycerides include succinic acid ester of monoglyceride, tartaric acid ester of monoglyceride, citric acid ester of monoglyceride, acetic acid ester of monoglyceride, and lactic acid ester of monoglyceride.

Other than the above, it is also possible to simultaneously use other types of emulsifiers such as sucrose fatty acid ester, polyglycerol fatty acid ester, sorbitan fatty acid ester, propylene glycol fatty acid ester, and polysorbate for stable existence of oil-in-water emulsions, although these emulsifiers are not greatly involved in the untangling properties.

(Oil or Fat)

In the present invention, when an emulsifier is emulsified by protein, emulsification can be improved by using oil or fat. Oil or fat to be used is not particularly limited, and animal and plant-derived oil or fat can be used. Examples include lard, beef tallow, milk fat, egg yolk, soybean oil, rapeseed oil, cocoa butter, rice bran oil, sunflower oil, corn oil, cottonseed oil, palm oil, coconut oil, sesame oil, olive oil, and perilla (Perilla frutescens var. frutescens) oil. Alternatively, these oils or fats that have been subjected to hardening, fractionation, or ester exchange can also be used. Among them, one or two or more oils or fats can be mixed and used. An oil substance such as tocopherol, which is a fat soluble vitamin for improving preservability, can also be added.

(Water Soluble Hemicellulose)

Water soluble hemicellulose is obtained by using oilseeds (such as palm, coconut, corn, and cottonseed), grains (such as rice and wheat) or beans (such as soybean, adzuki bean, and pea) as raw materials. Water soluble hemicellulose derived from beans, particularly soybean and pea, moreover, cotyledons are preferred from the solubility and industrial perspectives.

Water soluble hemicellulose can be obtained from raw materials containing hemicellulose by a method of water extraction or hot water extraction, a method of heat extraction under the conditions of acid or alkali, a method of extracting by enzymatic degradation, and the like.

A preferable example of a method for producing water soluble hemicellulose is as follows. Water soluble hemicellulose can be obtained by subjecting these raw materials to thermal degradation under acidic or alkaline conditions, preferably at a pH near the isoelectric point of each protein, preferably at 80° C. or more and 130° C. or less, more preferably at 100° C. or more and 130° C. or less, and fractionating a water soluble fraction by centrifugation and the like, and then drying the resulting product directly or after removing hydrophobic substances or low molecular weight substances by, for example, activated carbon treatment or resin adsorption treatment or ethanol precipitation treatment.

It is preferable to use an untangling-improving agent for noodles produced by further adding water soluble hemicellulose to monoglycerol fatty acid ester and protein since the untangling properties of noodles are markedly improved.

Although a preferable amount of water soluble hemicellulose added in the present invention is not particularly limited, it is 0.1 to 30% by weight, more preferably 0.5 to 20% by weight relative to the solid content of the untangling-improving agent.

(Method for Producing an Untangling-Improving Agent for Noodles)

Examples of the method for producing an untangling-improving agent for noodles of the present invention include a method comprising emulsifying a mixture of monoglycerol fatty acid ester and protein and a method comprising mixing an emulsified monoglycerol fatty acid ester and an emulsified protein.

An example of the method for producing an untangling-improving agent for noodles of the present invention will be shown. For example, an untangling-improving agent for noodles can be prepared by preliminarily emulsifying an oil phase having monoglycerol fatty acid ester as the main component and an aqueous phase containing protein and the like, followed by ordinary steps (homogenization, heat sterilization, cooling, aging, and the like). Preliminary emulsification is performed by mixing and stirring the aforementioned oil phase part and an aqueous phase part. The aqueous phase part is separately prepared by adding hydrophilic protein, water soluble hemicellulose, and dextrin. Subsequently, the resulting preliminary emulsion is homogenized using a homogenizer such as a valve-type homogenizer, followed by heat sterilization treatment, and homogenization is performed again as needed, to obtain an oil-in-water emulsion composition. The resulting oil-in-water emulsion composition is dried by an arbitrary method, whereby the untangling agent for noodles can be produced. Alternatively, an oil-in-water emulsion is obtained by adding octenylsuccinic acid starch, dextrin, and the like to monoglycerol fatty acid ester, followed by homogenization and the like. Protein is added to this oil-in-water emulsion, followed by heat sterilization treatment and drying, whereby the untangling-improving agent for noodles can be produced. It should be noted that the order of the addition of additives or the order of the emulsification, i.e., adding an oil phase to an aqueous phase or an aqueous phase to an oil phase, etc., can be arbitrarily determined in accordance with the situation.

The form of the untangling-improving agent is not particularly limited. For example, an oil-in-water emulsion in the form of a liquid as obtained by the aforementioned method, a paste, a powdered oil-in-water emulsion obtained by drying the aforementioned liquid or paste oil-in-water emulsion, and a granular oil-in-water emulsion obtained by further granulating the aforementioned powdered oil-in-water emulsion are given as examples. As a drying method, spray drying, drum drying, freeze drying, belt drying, and the like can be used.

While it is essential to incorporate protein and monoglycerol fatty acid ester into the untangling-improving agent, other additives can be simultaneously used as appropriate for the purposes of, for example, adjusting the quality of noodles. Examples of other additives include monosaccharides such as glucose and fructose, oligosaccharides such as sucrose, maltose, lactose, raffinose, maltotriose, trehalose, stachyose, and maltotetraose, sugar alcohol, polysaccharides such as dextrin, glue plant, agar, carrageenan, furcellaran, tamarind seed polysaccharides, tara gum, karaya gum, tragacanth gum, pectin, xanthan gum, sodium alginate, guar gum, ghatti gum, locust bean gum, pullulan, gellan gum, gum arabic, curdlan, crystalline cellulose, methyl cellulose, hydroxypropyl methylcellulose, hyaluronic acid, cyclodextrin, chitosan, carboxymethylcellulose (CMC), propylene glycol alginate, and various kinds of starch such as processed starch, hydrolysates of these polysaccharides, gelatin, soluble collagen, salts such as a calcium reinforcing agent, and acidulants such as acetic acid, citric acid, lactic acid, adipic acid, and gluconic acid.

Although a method for adding the untangling-improving agent to noodles is not particularly limited, examples of a method of kneading noodle dough of cooked noodles, instant noodles, and pasta with the addition of the untangling-improving agent include (1) a method of adding the untangling-improving agent as a powder by mixing it with flours such as wheat flour and (2) a method of adding the untangling-improving agent by dissolving it in water for kneading with salt, lye water, and seasonings. Examples of a method of surface treatment of noodle strands include (1) a method of surface treatment including dressing cooked noodles, instant noodles, or pasta with an aqueous solution of the untangling-improving agent, (2) a method including spraying an aqueous solution of the untangling-improving agent to cooked noodles, instant noodles, or pasta, (3) a method of surface treatment including dissolving the untangling-improving agent in liquid seasonings in advance, and then covering pasta and noodles with the resulting seasonings, and (4) a method of surface treatment including mixing the untangling-improving agent with powder seasonings, and then covering cooked noodles, instant noodles, or pasta with the resulting seasonings. These methods are selected in consideration of specific properties associated with each food product such as the production line and in what form the food product is sold.

Although the amount of the untangling-improving agent added to noodles varies according to the kind and formulation of noodles, the amount added is for example preferably 0.1 to 5% by weight, more preferably 0.5 to 3% by weight relative to the powder weight of wheat flour and the like.

Processed food products of grains, namely noodles that are obtained by a method including adding the untangling-improving agent to noodles, have favorable untangling properties. Accordingly, noodles obtained by the present invention are very easy to eat and tasty. Also, for example, in the case of cooked noodles, even after one to two days of refrigerated storage after preparation, their untangling properties are maintained, adhesion between noodles is markedly inhibited, and the elasticity and chewiness of noodles are also maintained. Moreover, noodles attain excellent processability such as being easy to mix and less likely to crush during their production because favorable untangling properties are imparted to noodles.

Hereinbelow, examples will be described; however, the technical idea of the present invention is not limited by the following examples.

Note that in the examples, parts and % are based on weight.

Types of emulsifier (Examples 1 to 6, Comparative Examples 1 to 2)

Untangling-improving agents for noodles were prepared according to the formulations shown in Table 1. Each emulsifier and oil or fat were melted by heating. Soybean protein and dextrin were dissolved in water and heated. Preliminary emulsification was carried out by heating the oil phase and aqueous phase to 70° C. or more and mixing them, followed by stirring with a homomixer for 10 minutes. The resulting preliminary emulsion was homogenized with a homogenizer under a pressure of 150 kgf/cm² and then dried by spray drying until a water content of 5% or less was achieved, whereby untangling agents for noodles were obtained. Materials used were Emulsy MO (93% or more of monoglyceride purity) (Riken Vitamin Co., Ltd.), Poem B-10 (Riken Vitamin Co., Ltd.), Poem W-10 (Riken Vitamin Co., Ltd.), Poem P-200 (Riken Vitamin Co., Ltd.), DIMODANUP-T/B (90% or more of monoglyceride purity) (Danisco), GRINSTED SSL (Danisco), SLP white (Tsuji Oil Mills Co., Ltd.), Emusol S-10V (Kao Corporation), soybean protein isolate (Fuji Oil Co., Ltd.), palm oil (Fuji Oil Co., Ltd.), and dextrin (Matsutani Chemical Industry Co., Ltd.)

Evaluation of Chinese Noodles

Water for kneading was prepared by dissolving 20 g of dietary salt and 10 g of an untangling agent for noodles into 450 g of water. The water for kneading was added to a mixture of 600 g of wheat flour, 390 g of tapioca starch, and 10 g of wheat gluten, followed by kneading to obtain noodle dough. The dough was rolled and cut out into Chinese noodles with a No. 20 slitting cutter. The Chinese noodles were boiled for 80 seconds, rinsed with water, and divided into tortoise shell containers in small portions of 100 g each, followed by storage at 4° C. for two days. The resulting Chinese noodles were evaluated for the untangling properties and the quality of noodles (elasticity and hardness).

Evaluation Method of Noodles

Noodle soup was added to the noodles that had been stored for two days and the state of untangling was observed visually. With regard to the texture of noodles, elasticity and hardness were evaluated by six expert panelists. The untangling properties of noodles were evaluated on a 1-5 scale with 5 representing excellent untangling properties and 1 representing extremely poor untangling properties, and the average of the evaluation made by six panelists was obtained as the average score. An average score of 3.0 or higher was deemed as acceptable. Also, noodles having elasticity and noodles having moderate, favorable hardness were determined as having good noodle quality with favorable noodle texture.

TABLE 1

| | | Example | Example | Example | Example | Example | Example | Comparative | Comparative |
|---|---|---|---|---|---|---|---|---|---|
| | | 1 | 2 | 3 | 4 | 5 | 6 | Example 1 | Example 2 |
| Soybean | | 10 | 10 | 10 | 10 | 10 | 10 | 10 | 10 |
| protein | | | | | | | | | |
| isolate | | | | | | | | | |
| Emulsy MO | Monoglycerol | 30 | | 25 | 25 | 25 | 25 | | |
| | fatty acid ester | | | | | | | | |
| SunSoft No. | Monoglycerol | | 30 | | | | | | |
| 8000v | fatty acid ester | | | | | | | | |
| Poem B-10 | Succinic acid | | | | | | | | |
| | ester of | | | 5 | | | | | |
| | monoglyceride | | | | | | | | |
| Poem W-60 | Diacetyl tartaric | | | | 5 | | | | |
| | acid ester of | | | | | | | | |
| | monoglyceride | | | | | | | | |
| SLP white | Lecithin | | | | | 5 | | | |
| GRINSTED | Sodium stearoyl | | | | | | 5 | | |
| SSL | lactylate | | | | | | | | |
| Poem P-200 | Diglycerol fatty | | | | | | | 30 | |
| | acid ester | | | | | | | | |
| Emusol | Sorbitan fatty | | | | | | | | 30 |
| S-10v | acid ester | | | | | | | | |
| Palm oil | | 10 | 10 | 10 | 10 | 10 | 10 | | 10 |
| Dextrin | | 50 | 50 | 50 | 50 | 50 | 50 | 50 | 50 |
| Water | | 150 | 150 | 150 | 150 | 150 | 150 | 150 | 150 |
| D + 1 | Untangling | 3.2 | 3.3 | 4.0 | 4.2 | 4.3 | 4.3 | 2.3 | 2.2 |
| | properties of | | | | | | | | |
| | noodles | | | | | | | | |
| | Elasticity of | Elastic | Elastic | Elastic | Elastic | Elastic | Elastic | Dense | Weak |
| | noodles | | | | | | | | |
| | Hardness of | Favorable | Favorable | Favorable | Favorable | Favorable | Slightly | Hard | Soft |
| | noodles | | | | | | soft | | |

The untangling properties of the noodles of Examples 1 to 6 were favorable and the noodles had elasticity and favorable hardness, revealing that favorable untangling properties of noodles were successfully obtained by using distilled monoglycerol fatty acid ester which contains high purity monoglycerol fatty acid ester. Also, from a comparison between Examples 1 to 2 and Examples 3 to 6, it was found that the untangling properties of noodles and the quality of noodles were further improved by using monoglycerol fatty acid ester in combination with organic acid esters of monoglycerides, lecithin, and sodium stearoyl lactylate.

Meanwhile, with regard to Comparative Examples 1 to 2, in which monoglycerol fatty acid ester was not used, the untangling properties of noodles were poor. Further, the quality of noodles was evaluated as poor in both Comparative Examples 1 to 2 as Comparative Example 1 was hard, while Comparative Example 2 was soft.

Types of Protein (Examples 7 to 10)

Untangling-improving agents for noodles were prepared according to the formulations shown in Table 2. Each emulsifier and oil or fat were melted by heating. Soybean protein and dextrin were dissolved in water and heated. Preliminary emulsification was carried out by heating the oil phase and aqueous phase to 70° C. or more and mixing them, followed by stirring with a homomixer for 10 minutes. The resulting preliminary emulsion was homogenized with a homogenizer under a pressure of 150 kgf/cm² and then dried by spray drying until a water content of 5% or less was achieved, whereby untangling-improving agents for noodles were obtained. Chinese noodles were prepared by adding the resulting untangling-improving agents for noodles, and the untangling properties and the quality of noodles were evaluated in a similar manner to Example 1. Materials used were soybean polysaccharides (Fuji Oil Co., Ltd.), A-gluG (Glico Nutrition Co., Ltd.), and dried egg white M No. 200 (Kewpie Corporation).

TABLE 2

| | | Example 7 | Example 8 | Example 9 | Example 10 |
|---|---|---|---|---|---|
| Soybean protein | | 10 | | | |
| isolate | | | | | |
| Soybean | | 10 | 1 | | 10 |
| polysaccharides | | | | | |
| Wheat protein | A-gluG | | 10 | | |
| Egg white | Dried egg white type | | | 5 | |
| | M No. 200 | | | | |
| Mung bean | | | | | 10 |
| protein | | | | | |
| Emulsy MO | Monoglycerol fatty | 30 | 30 | 30 | 30 |
| | acid ester | | | | |
| Palm oil | | 10 | 10 | 10 | 10 |
| Dextrin | | 40 | 40 | 40 | 40 |
| Water | | 150 | 150 | 150 | 150 |
| D + 1 | Untangling properties | 4.8 | 4.5 | 4.0 | 4.7 |
| | of noodles | | | | |
| | Elasticity of noodles | Elastic | Elastic | Elastic and | Elastic |
| | | | | bouncy | |
| | Hardness of noodles | Favorable | Favorable | Favorable | Favorable |

Examples 7 to 10 were favorable with noodles having elasticity as well as favorable hardness. Similarly to soybean protein isolate, favorable results were obtained with wheat protein, egg white, and mung bean protein. Also, from a comparison between Example 1 and Example 7, it was found that the untangling properties of noodles and the quality of noodles were further improved by using monoglycerol fatty acid ester in combination with soybean polysaccharides.

Ratios Between Protein and Monoglycerol Fatty Acid Ester (Examples 11 to 13 and Comparative Example 3)

Untangling-improving agents for noodles were prepared according to the formulations shown in Table 3. Each emulsifier and oil or fat were melted by heating. Soybean protein and dextrin were dissolved in water and heated. Preliminary emulsification was carried out by heating the oil phase and aqueous phase to 70° C. or more and mixing them, followed by stirring with a homomixer for 10 minutes. The resulting preliminary emulsion was homogenized with a homogenizer under a pressure of 150 kgf/cm² and then dried by freeze drying until a water content of 5% or less was achieved, whereby untangling-improving agents for noodles were obtained. Chinese noodles were prepared by adding the resulting untangling-improving agents for noodles, and the untangling properties and the quality of noodles were evaluated in a similar manner to Example 1. As monoglycerol fatty acid ester, Emulsy MO (Riken Vitamin Co., Ltd., 93% or more of purity of monoglycerol fatty acid ester) was used.

TABLE 3

| | | | | | Compar- |
|---|---|---|---|---|---|
| | | Example | Example | Example | ative |
| | | 11 | 12 | 13 | Example 3 |
| Soybean protein isolate | | 0.8 | 4 | 20 | 20 |
| Monoglycerol fatty acid | | 4 | 4 | 4 | 0 |
| ester | | | | | |
| Palm oil | | 2 | 2 | 2 | 2 |
| Dextrin | | 20 | 16 | 0 | 4 |
| Water | | 150 | 150 | 150 | 150 |
| D + 1 | Untangling | 3.2 | 3.5 | 3.3 | 1.3 |
| | properties of | | | | |
| | noodles | | | | |
| | Elasticity of | Elastic | Elastic | Elastic | Elastic |
| | noodles | | | | |
| | Hardness of | Favorable | Favorable | Favorable | Favorable |
| | noodles | | | | |

The untangling properties of noodles and the quality of noodles of Examples 11 to 13 were favorable, in which the ratios between soybean protein isolate: monoglycerol fatty acid ester were 1:5 to 5:1.

Evaluation of Noodles When a Non-Emulsified Untangling Agent Was Added (Comparative Example 4)

Into a mortar, 30 parts of monoglycerol fatty acid ester, 10 parts of soybean protein isolate, and 60 parts of dextrin were placed, followed by grinding to obtain Comparative Example 4. The resulting untangling agent for noodles could not be dispersed in water. Moreover, it could not be evenly dispersed in wheat flour either, leading to a failure in producing Chinese noodles.

Evaluation of Udon Noodles (Example 14)

Water for kneading was prepared by dissolving 30 g of dietary salt and 10 g of an untangling-improving agent for noodles prepared according to the formulation of Example 7 into 360 g of water. The water for kneading was added to a mixture of 800 g of wheat flour and 200 g of tapioca starch, followed by kneading to obtain noodle dough. The dough was rolled and cut out into udon noodles with a No. 10 slitting cutter. The udon noodles were boiled for 10 minutes, rinsed with water, and divided into tortoise shell containers in small portions of 100 g each, followed by storage at 4° C. for two days.

The udon noodles to which the untangling-improving agent for noodles was added maintained favorable untangling properties and had favorable texture with elasticity and chewiness even after two days of storage.

Evaluation of Surface-Treated Udon Noodles (Example 15)

Water for kneading was prepared by dissolving 30 g of dietary salt into 360 g of water. The water for kneading was added to a mixture of 800 g of wheat flour and 200 g of tapioca starch, followed by kneading to obtain noodle dough. The dough was rolled and cut out into udon noodles with a No. 10 slitting cutter. The udon noodles were boiled for 10 minutes, then rinsed with water. A 10% aqueous solution of the untangling-improving agent for noodles prepared according to the formulation of Example 7 was added in an amount of 3% relative to the boiled udon noodles, followed by thoroughly mixing with hand until uniformity was obtained. Subsequently, the udon noodles were divided into tortoise shell containers in small portions of 100 g each, followed by storage at 4° C. for two days.

The udon noodles that were subjected to surface treatment with the untangling-improving agent for noodles maintained favorable untangling properties and had favorable texture with elasticity and chewiness even after two days of storage.

1-20. (canceled)

21. A method for improving untangling of noodles comprising:
adding a powdered product or granule product to noodles, wherein the powdered product or granule product is obtained by drying an emulsion comprising a monoglycerol fatty acid ester and a protein.

22. The method according to claim 21, wherein the emulsion is an oil-in-water emulsion.

23. The method according to claim 22, wherein the emulsion comprises protein and the monoglycerol fatty acid ester at a ratio of protein: monoglycerol fatty acid ester of 1:0.1 to 1:10.

24. The method according to claim 22, wherein the monoglycerol fatty acid ester is a distilled monoglycerol fatty acid ester.

25. The method according to claim 24, wherein a purity of monoglyceride in the distilled monoglycerol fatty acid ester is 80% by weight or more.

26. The method according to claim 24, wherein a purity of monoglyceride in the distilled monoglycerol fatty acid ester is 85% by weight or more.

27. The method according to claim 21, wherein the powdered product or granule product further comprises a water soluble hemicellulose.

28. The method according to claim 27, wherein the water soluble hemicellulose is derived from soybean.

29. The method according to claim 27, wherein an amount of the water soluble hemicellulose in the powdered product or granule product is 0.1 to 30% by weight relative to a solid content of the powdered product or granule product.

30. The method according to claim 27, wherein an amount of the water soluble hemicellulose in the powdered product or granule product is 0.5 to 20% by weight relative to a solid content of the powdered product or granule product.

31. The method according to claim 21, wherein the powdered product or granule product further comprises one or more emulsifiers selected from the group consisting of organic acid esters of monoglycerides, lecithin, and stearoyl lactylate.

32. The method according to claim 21, wherein the protein is one or more heat-coagulable proteins selected from heat-coagulable proteins derived from beans, wheat, and egg white.

33. The method according to claim 21, wherein the protein is a soybean protein.

34. A method for producing noodles comprising:
adding a powdered product or granule product to noodles, wherein the powdered product or granule product is obtained by drying an emulsion comprising a monoglycerol fatty acid ester and a protein.

35. The method according to claim 34, comprising:
adding the powdered product or granule product to a noodle dough, or preparing a solution by dissolving the powdered product or granule product in water and adding the solution to the noodle strands by treating a surface of noodle strands with the solution.

36. The method according to claim 34, wherein the powdered product or granule product is added in an amount of 0.1 to 5% by weight relative to powder weight of the noodle.

37. The method according to claim 34, wherein the powdered product or granule product is added in an amount of 0.5 to 3% by weight relative to powder weight of the noodle.
